(19) United States
(12) Patent Application Publication
(10) Pub. No.: US 2026/0298767 A1
(43) Pub. Date: Oct. 1, 2026

(54) Method for Detecting a Change in Status in an Underwater System

(71) Applicant: Robert Bosch GmbH, Stuttgart (DE)

(72) Inventors: Markus Kubacki, Wuerzburg (DE); Gottfried Hendrix, Gemuenden (DE); Alexandre Orth, Sao Paulo (BR)

(21) Appl. No.: 19/472,413

(22) PCT Filed: Mar. 26, 2024
(86) PCT No.: PCT/EP2024/058039

§ 371 Date: Oct. 3, 2025

(30) Foreign Application Priority Data
Apr. 5, 2023 (DE) 10 2023 203 156.6

(51) Int. Cl. G01M 5/00; G01M 13/003

(52) U.S. Cl. CPC G01M 5/0066; G01M 13/003

(57) ABSTRACT

A method for detecting a change in status in an underwater system, a computer unit and a computer program for carrying out the method, and an underwater system are disclosed. The underwater system includes a plurality of underwater devices, each including at least one actuator and at least one vibration sensor. The method includes (i) receiving a signal of the vibration sensor from at least one of the plurality of underwater devices, (ii) comparing the received signal with a reference signal of the vibration sensor for the at least one underwater device, (iii) determining a deviation between the reference signal and the received signal, and (iv) detecting a change in status in the underwater system as a function of the determined deviation.

The present invention relates to a method for detecting a change in status in an underwater system (100), a computer unit and a computer program for carrying out said method, and an underwater system.

### BACKGROUND OF THE INVENTION

Underwater systems, such as offshore petroleum or natural gas conveying plants, include a variety of line systems that employ process valves that control or block the flow rate of the conveyed medium. As such equipment is operated at great depths at sea, its components are subjected to heavy stresses due to ambient conditions. If these loads lead to a malfunction, for example of the process valves, significant damage may occur.

### DISCLOSURE OF THE INVENTION

The present invention relates to a method for detecting a change in status in an underwater system, a computer unit and a computer program for carrying out said method. Advantageous configurations are the subject matter of the dependent claims and the following description.

The underwater system has a plurality of underwater devices each including at least one actuator and at least one vibration sensor. For example, the underwater devices may be linear or rotational actuators for actuating process valves. These may in particular comprise an electrical, electro-hydraulic, and/or electro-pneumatic drive comprising an electrical/electronic controller. Further examples of underwater devices include pumps and/or compressors, which may also include electrical/electronic control. The at least one vibration sensor may be disposed within and electrically connected to the respective underwater device so that these signals from the vibration sensor may be received. In particular, the vibration sensor is disposed on a circuit board, e.g. main circuit board (so-called mainboard or a motherboard) of the controller of the respective underwater device or in an actuator. The underwater devices may be arranged at different positions in the underwater system spaced apart from one another and at least partially connected to one another via a line system, for example.

By means of the vibration sensors, changes of status in such an underwater system can be monitored, e.g. in order to detect and avoid malfunctions of individual components early on. Furthermore, for example, the actual present opening positions, such as opening cross-sections, of the process valves in the underwater system can be determined.

Specifically, in the method according to the invention, a signal from the vibration sensor of at least one of the plurality of underwater devices is received. The one signal (of an underwater device) or the plurality of signals (of a plurality of underwater devices) may be received from a computing unit configured to evaluate the one or more vibration sensor signals and perform, for example, frequency analyses. The computing unit may be one or more controllers of the underwater devices and/or may be a separate computing unit. The signal from the vibration sensor of the at least one of the plurality of underwater devices may be received continuously or at predetermined time intervals for a predetermined period of time. The one or more vibration sensor signals received may be stored by the computing unit, e.g., for later analysis, etc.

The received signal is compared to a reference signal of the vibration sensor for the at least one underwater device. The reference signal may be a signal that the vibration sensor outputs in a predetermined reference state (e.g., valve on, valve off, device error-free, etc., see below) of the at least one underwater device. The reference signal may be determined from a plurality of vibration sensor signals determined in the predetermined reference state. For example, the computing unit may comprise an (AI) model (“artificial intelligence”) trained on the plurality of vibration sensor signals to calculate the reference signal of the at least one underwater device. For example, if the underwater device is a linear actuator for an underwater process valve, then the reference state may be, for example, a closed or fully open state of the process valve. It is also possible that a reference signal is determined for a plurality of vibration sensors in a reference state of the entire underwater system, wherein in this case the reference state may be, for example, a trouble-free operation of the underwater system.

As part of the comparison, a deviation between the reference signal and the received signal is determined. For example, the deviation may be determined by determining a difference between a time-based signal received from the vibration sensor over a predetermined period of time and the reference signal. In this case, the deviation itself may represent a time-dependent signal, the amplitudes, frequencies, etc. of which may be evaluated. Alternatively or additionally, the vibration sensor signal and the reference signal may be transformed into the frequency range, e.g., by means of a Fast Fourier Transform (FFT), and the deviation may be determined, e.g., by means of an amplitude and/or frequency difference between the two signals. It is also possible that the deviation can be determined by means of so-called artificial intelligence (AI, i.e. a so-called machine learning method or machine pattern recognition method). For this purpose, the AI can be trained with a plurality of reference signals as well as with a plurality of vibration sensor signals from already detected changes of status, which can be stored in a data memory. The trained AI may then determine a deviation of the received vibration sensor signal from the reference signal based on pattern detection.

Depending on the determined deviation, e.g., when a parameter (e.g., maximum amplitude, amplitude for certain frequencies or orders, etc.) of the determined deviation exceeds a predetermined threshold value, a change in status in the underwater system is detected. For example, if a maximum value of the difference between the time-based vibration sensor signal and the reference signal and/or the amplitude/frequency difference described above exceeds a predetermined threshold value, a change in status in the underwater system may be concluded.

According to one embodiment, an action may be taken when a change in status is detected. In particular, the computing unit may initiate/perform further steps/actions to respond to the state change based on the detected change in status. In this case, for example, information, for example an analog or digital signal, can be output to a higher-level controller.

According to one embodiment, a change in status in the underwater system can occur by opening or closing an underwater process valve. To this end, at least one of the plurality of underwater devices may be configured to actuate an underwater process valve. As already described above, this can be a linear or rotational actuator, for example, with which the underwater process valve can be opened and closed, depending on the type of the underwater process valve. In this case, the vibration sensor of the underwater device may also be attached to/in/on the linear or rotational actuator. During the opening and closing of the process valve, a significant change in flow rate through the process valve and in a line connected thereto occurs from a particular change in the opening position, which corresponds to a particular size of the opening cross-section. This change in flow rate triggers a change in vibration (e.g., a noise) that may be mechanically transmitted and detected by the vibration sensor. In other words, at a moment after actuation of the actuator, a flow rate is released through the process valve (start of opening of the process valve), reaches a plateau (end of opening of the process valve), begins to decrease (start of closing of the process valve) or ends (end of the process valve), thereby changing a state of the underwater device. The change in vibration triggered thereby may be detected by the deviation of the vibration sensor signal from its reference signal. Intermediate positions may also be detectable depending on noise levels.

Thus, according to one embodiment, the action that may be taken when a change in status is detected may be to determine an opening position of the underwater process valve during opening or closing, wherein determining takes place by means of a signal from the vibration sensor of the at least one underwater device for actuating the underwater process valve. In one embodiment, upon detection of an opening and/or closing start of a process valve, for example, a signal from the vibration sensor of the underwater device may be used for a predetermined time and/or until an opening or closing is detected, received, and compared to its reference signal. This means that upon detection of a first change in status, namely, here the start of opening or closing of the process valve, the vibration sensor signal is further recorded and compared to the reference signal. For example, the predetermined time in which the vibration sensor signal is further recorded may be determined based on predetermined opening and closing times of the process valve. In so doing, the predetermined time may be selected greater than the predetermined opening and closing times of the process valve to reliably capture/record the vibration signal throughout an opening or closing operation. Intermediate positions can be interpolated based on a detected start and end position or based on a start position and opening or closing times.

Further, the vibration sensor signal of the underwater device may be matched, for example, with an open position sensor of the process valve. For example, the start of opening of the process valve may be determined by the deviation of the vibration sensor signal from the reference signal detected as a change in status and may be associated with a corresponding open position indicator of the open position sensor. Likewise, a fully open process valve may be associated with a corresponding open position indicator of the open position sensor. Based on a characteristic curve of the process valve, which shows a connection between the opening cross-section (position) and the flow rate through the valve, the flow through the process valve can also be directly determined from the vibration sensor signals.

According to one embodiment, a change in status in the underwater system takes place by an occurrence of an anomaly in at least one of the plurality of underwater devices. This may be caused, for example, by a failure of an underwater device or by a change in a cross-section of a line due to a failure/fault in the line system. The change in the line cross-section or the flow change associated therewith can lead to a change in vibration in the line system, which can be detected by a mechanical coupling/connection of the plurality of underwater devices to the line system or by sound waves from their vibration sensors.

In addition, wear on the underwater process valve can be determined as a measure to be taken based on a comparison between the vibration sensor signal and the reference signal. To this end, a variety of opening and closing operations of the underwater process valve may be monitored using the vibration sensor signal of its underwater device. In particular, the deviations of the vibration sensor signal from its reference signal may be recorded during each opening and closing operation, and changes in the deviations determined. For example, these changes may indicate wear of the edges of the process valve and may represent a measure of wear. If a change of the deviation of the vibration sensor signal from its reference signal during an opening or closing operation exceeds a predetermined value, this may indicate, for example, a defect in the process valve.

According to one embodiment, the action that may be taken when a change in status is detected may be a determination of a position of the anomaly in the underwater system by means of signals from the vibration sensors of more than one of the plurality of underwater devices. A position of the anomaly is intended to be understood as a position/location/part from which increased vibration can be detected by the vibration sensors of the plurality of underwater devices. In particular, vibration sensor signals from a plurality of spaced-apart underwater devices of the underwater system may be analyzed, for example, if it is detected at one of the underwater devices that a deviation of the vibration sensor signal from the reference signal indicates an anomaly. Deviations of all vibration sensor signals from their reference signals can be determined for this purpose and a cause of the change in status can be detected by a comparison of the individual deviations determined.

According to one embodiment, the position of the anomaly may be determined by determining time intervals between vibration sensor signals, e.g., between characteristic values of the vibration sensor signals. Such characteristic values may be, for example, a maximum value of the determined deviation when it is determined based on time. According to one embodiment, a frequency analysis may alternatively or additionally be performed to determine the characteristic value of the individual deviations determined. In so doing, the vibration sensor signal and the reference signal may be transformed into the frequency range, e.g., by means of a Fast Fourier Transform (FFT). For example, the characteristic value may then be a maximum amplitude of deviation between the reference signal and the vibration sensor signal. This may be associated with a particular frequency, which may be the same for all analyzed vibration sensor signals of the first and the further underwater systems, wherein the time at which the maximum amplitude occurs and its value may be different. By means of the time distances between the maximum amplitudes of the vibration sensor signals of the first and the further underwater devices, the location of the fault/fault can be determined based on known line lengths and the speed of sound between the underwater devices in the underwater system.

In addition to the time intervals between the maximum amplitudes of the vibration sensor signals, the values of the amplitudes can additionally be taken into account to determine the location of the fault. The frequency at which the maximum amplitudes of the vibration sensor signals of all underwater devices occur may also be used to infer the type of interference/fault. For example, this information may be sent to an output unit of the underwater system to initiate, for example, troubleshooting by a user.

A computing unit according to the invention, e.g., a controller for an underwater device or an underwater controller master, is designed, in particular in terms of programming, to carry out a method according to the invention.

The implementation of a method according to the invention in the form of a computer program or computer program product comprising program code for performing all of the method steps is also advantageous because this results in particularly low costs, especially if an executing control device is still used for other tasks and is therefore provided in any event. Suitable data carriers for providing the computer program include, in particular, magnetic, optical, and electrical storage devices such as hard disks, flash memory, EEPROMs, DVDs, etc. Downloading a program via computer networks (internet, intranet, etc.) is also possible.

Further advantages and embodiments of the invention will emerge from the description and the accompanying drawings.

Of course, the above-mentioned features and those to be explained below can be used not only in the combination indicated in each case, but also in other combinations or on their own, without going beyond the scope of the present invention.

The invention is illustrated schematically by means of exemplary embodiments in the drawings and is described in detail below with reference to the drawings.

### DESCRIPTION OF THE DRAWINGS

FIGS. 1a to 1c schematically show one example of a determination of an opening operation of an underwater process valve according to one embodiment of the invention.

FIG. 2 schematically shows an example of a construction of an underwater system in which a cause for a change in status according to a further embodiment of the invention can be detected.

### DETAILED DESCRIPTION OF THE DRAWINGS

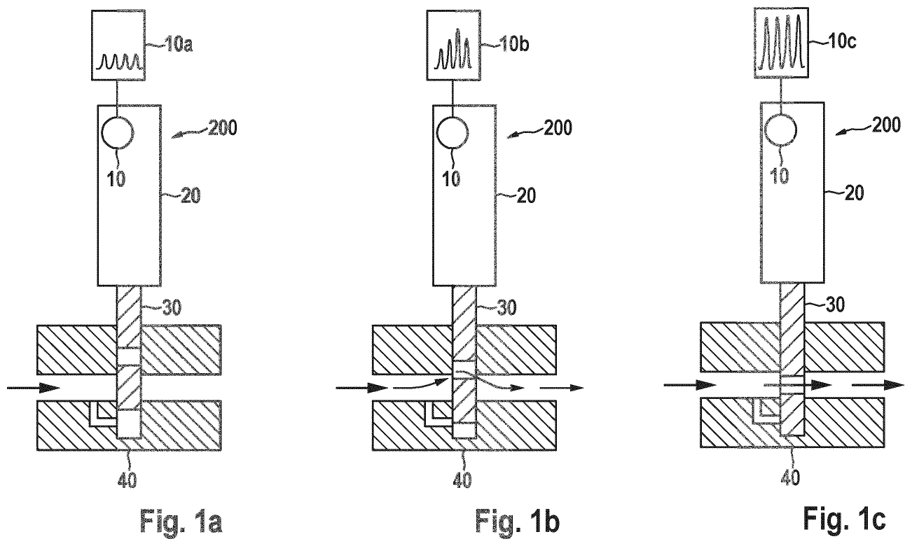

FIGS. 1a to 1c schematically show one example of a determination of an opening operation of an underwater process valve 40 according to one embodiment of the invention. The underwater process valve 40 is connected to an underwater device 200 that includes an actuator 20 having a disc 30 and a vibration sensor 20.

In FIG. 1a, an opening cross-section of the process valve 40 is closed by the disc 30 so that no flow (indicated by the arrow in FIG. 1a) flows through the process valve 40.

The vibration sensor 10 of the underwater device 200 attached to/in/on the actuator 20 measures vibrations 10a, 10b, 10c that are applied to the actuator 20. With the process valve 40 closed, the actuator 20 is subjected to a fundamental vibration 10a of a line system (not shown) to which the process valve 40 and the underwater device 20 are mechanically connected. This fundamental vibration 10a is detected by the vibration sensor 10 and may serve as a reference signal to detect changes in status of the process valve 40 from change in vibrations.

When the process valve 40 is opened (FIG. 1b), an initial flow (indicated by the thin arrows in FIG. 1b) through the process valve 40 triggers a change of vibration (e.g., increase in vibration amplitudes) detected by vibration sensor 10. Based on a characteristic of the vibration 10b now detected as compared to the fundamental vibration 10a (deviation between the reference signal and the received signal), an opening start of the process valve 40 can be detected as a change in status.

FIG. 1c shows the process valve 40 in a fully opened state with the entire flow (indicated by three equal arrows) flowing through the process valve 40. The increased flow through the process valve 40 again alters the vibrations to which the actuator 20 is exposed so that, based on the changed vibration characteristic 10c, the fully open position of the process valve can be determined as a further change in status by means of the changed vibration sensor 10. As the vibrations acting on the actuator 20 detected by the vibration sensor 10 continuously change from the start of opening to the full opening of the process valve 40, a position of the disc 30 during the opening operation may be determined using the vibration sensor signal.

It is understood that the effects described may occur in reverse order during a closing operation of process valve 40, and thus may be detected in the same manner.

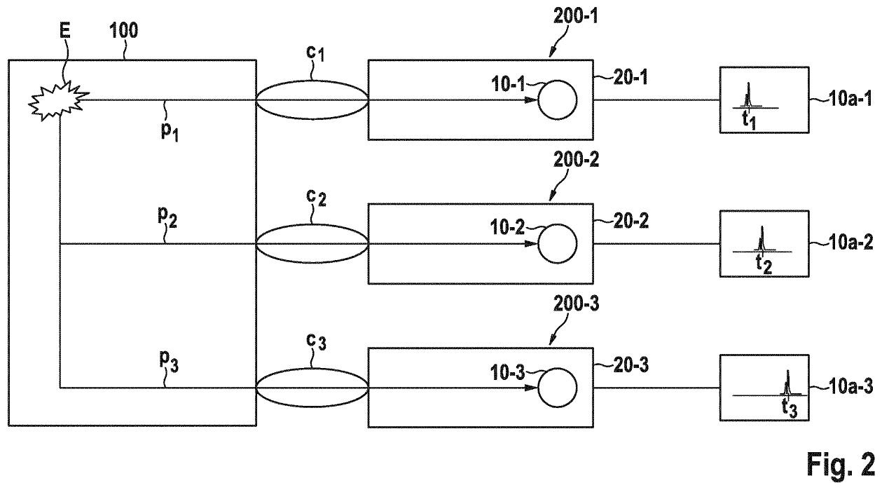

FIG. 2 schematically shows an example of a construction of an underwater system 100 in which a cause for a change in status according to a further embodiment of the invention can be detected. The underwater system 100 shown includes three exemplary power systems, p₁, p₂, p₃, to which, by means of mechanical couplings, c₁, c₂, c₃, underwater devices, 200-1, 200-3, 200-3, are connected to actuators 20-1, 20-2, 20-3 and vibration sensors 10-1, 10-2, 10-3, as shown.

In the underwater system 100, interference occurs at a position E of the line system p₁ (indicated by the explosion symbol). This interference may result in a vibrational change 10d in the line system p₁, which may be transmitted to the line system p₁ by means of the mechanical coupling c₁ of the underwater device 200-1, or to the vibration sensor 10-1 by means of sound waves. In the illustrated example, it detects the change in vibration 10d (deviation between a reference signal of vibration sensor 10-1 and the received signal) at a time t₁.

As the line system p1 is connected to the further power systems p2, p3, the change in vibration 10d is also detected by the vibration sensors 10-2, 10-3 of the further underwater devices 200-2, 200-3. However, due to the different line lengths, they record the change in vibration at later times t₂, t₃. The times t₁, t₂, t₃ at which the change in vibration has been detected by the vibration sensors 101, 10-2, 10-3 may be stored as timestamps in a computing unit, which may be, for example, a controller for the underwater devices and/or an underwater control master. Based on the time intervals between the individual times t₁, t₂, t₃ and the known line lengths of the line systems p₁, p₂, p₃, the position E of the interference can then be calculated. Due to the increased speed of sound underwater, the described method may also be used to detect interferences in adjacent underwater systems.

1. A method for detecting a change in status in an underwater system comprising a plurality of underwater devices, each including at least one actuator and at least one vibration sensor, the method comprising:
receiving a signal of the vibration sensor from at least one of the plurality of underwater devices;
comparing the received signal with a reference signal of the vibration sensor for the at least one underwater device;
determining a deviation between the reference signal and the received signal; and
detecting a change in status in the underwater system as a function of the determined deviation.

2. The method according to claim 1, wherein an action is performed when a change in status is detected.

3. The method according to claim 1, wherein at least one of the plurality of underwater devices is configured to actuate an underwater process valve, and wherein a change in status in the underwater system occurs by opening or closing the underwater process valve.

4. The method according to claim 2, wherein the action is to determine a current open position of the underwater process valve during opening and/or closing by way of the signal of the vibration sensor of the at least one underwater device for actuating the underwater process valve.

5. The method according to claim 1, wherein a change in status in the underwater system takes place by an occurrence of an anomaly in at least one of the plurality of underwater devices.

6. The method according to claim 5, wherein the action is to determine a position of the anomaly in the underwater system by way of signals from the vibration sensors of more than one of the plurality of underwater devices.

7. The method according to claim 6, wherein the position of the anomaly is determined by determining time intervals between characteristic values of the vibration sensor signals.

8. A computing unit configured to carry out the method according to claim 1.

9. A computer program causing a computing unit to carry out the method according to claim 1 when executed on the computing unit.

10. A machine-readable storage medium having the computer program according to claim 9 stored thereon.

11. An underwater system, comprising:
a plurality of underwater devices, each including at least one actuator and at least one vibration sensor;
at least one line system to which the plurality of underwater devices are connected; and
the computing unit according to claim 8.
